(19) United States
(12) Patent Application Publication
(10) Pub. No.: US 2006/0137625 A1
(43) Pub. Date: Jun. 29, 2006

(54) Animal collar with built-in leash

(76) Inventor: Joseph Conte, Ladera Ranch, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 11/023,745

(22) Filed: Dec. 27, 2004

(51) Int. Cl. A01K 27/00

(52) U.S. Cl. 119/858

(57) ABSTRACT

A unitary, flexible strap having an adjustable closure at its free ends such that the ends may be joined to form a closed loop of selected diameter. The strap has an outer surface to which an enclosure is fixedly mounted, the enclosure providing an interior space for mounting a spool rotationally within. The spool provides a cord wrapped around it so that the cord may be fed out from the spool by rotation through an aperture upon drawing a handle mounted at a free end of the cord. The handle and cord form a leash for control of an animal when the strap is fastened about the animal.

### BACKGROUND OF THE INVENTION

1. Related Applications: none

2. Field of the Invention

This invention relates generally to animal collars and leashes and more particularly to an animal collar with built-in leash.

3. Description of Related Art

The following art defines the present state of this field and each disclosure is hereby incorporated herein by reference:

Forte, U.S. Pat. No. 6,367,428 discloses a combination dog collar and leash system. A strap has a length with a midpoint and with an interior surface and an exterior surface and an inner end and an outer end. The outer end is folded to form a first loop constituting a handle with a first stitching at the outer end forming a leash. The inner end is folded to form an overlapping extent with a second stitching at the inner end. A first segment of a pile type fastener is secured to the strap from adjacent to the outer end along the length of the handle. A second segment of a pile type fastener is secured to the exterior surface from adjacent to the inner end. A portion of a plastic buckle is secured in the second loop. A portion of a plastic buckle is slidably secured to the strap adjacent to the center of the strap.

Taplin, U.S. Pat. No. 4,584,967 discloses a collar/leash combination for pets wherein a flexible member with a buckle attached to one end so that a collar can be formed by inserting the other end of the member through the buckle. Velcro material or loops are used to keep the leash section of the member wound around the pet's collar when the leash is not in use. A handle loop is formed at the other end of the flexible member. An alternate embodiment uses a pouch to keep the leash in place, attached to the pet's collar.

Giacobbe, U.S. Pat. No. 5,099,799 discloses a collar/leash device which includes a unitary elongated flexible flat member having an outer surface and an inner surface, a first end section, and an opposing second end section. The first end section is provided with a buckle member including a frame member and a locking pin member that pivots on the inner end of the frame member. A plurality of apertures are disposed in spaced relationship through the flexible flat member at a preselected distance from the buckle member. The pin member is adapted to be insertable through a selected aperture in the flexible flat member whereby a collar section of selected size is provided by passing the opposing second end section through the buckle frame until the pin member is inserted through the selected aperture. The flexible flat member portion extending from the selected aperture to the second end section provides a leash section. Attaching members are provided for releasably fastening the leash section of the flexible flat member in wound position about the collar section when the leash section is not in use. The second end section is releasably attachable to selected points on the flexible flat member to provide a loop-like configuration which serves as a hand-grip loop section to be received by the hand of a person to hold the leash or to releasably connect the leash to a fixed object.

Stout et al, U.S. Pat. No. 5,297,514 discloses a pet collar (10) including a first web portion (18) attached to a second web portion (19) by a locking device (16). The locking device (16) includes opposed plates (22, 23) each of which have a plurality of apertures (27, 28, 29) therein which receive the web portions (18, 19). A lock barb (26) is positioned at each end of each plate (22, 23) and the lock barbs (26) of opposed plates (22, 23) are opposed to each other so that when tension is placed upon a web portion (18, 19), the opposed lock barbs (26) will engage the web portion (18, 19) positioned therebetween.

Koch, U.S. Pat. No. 5,785,010 discloses a collar for holding and leading animals comprising a strap, a quick-locking clasp for putting the strap on and for taking it off, and a fastener for attaching a lead or a chain. The collar is especially characterized by the features that the strap is fixedly connected so as to form an endless strap, the quick-locking clasp being provided parallel to a strap section to be bridged for the purpose of bridging said strap section and for adjusting a predetermined length of said strap.

Hoffman et al, U.S. Pat. No. 5,947,062 discloses a restraint system which can remain on an animal at all times. In one embodiment, the restraint system includes a strap which serves as both a collar and a leash. The restraint system can be in either an extended state or a retracted state. In the extended state, the collar portion is positioned around the animal's neck and the leash portion extends from the collar portion to the animal owner's hand. In the retracted state, the entire restraint system is stored around the animal's neck by reversibly attaching the leash portion to the collar portion, as well as to the leash portion itself, in an overlapping spiral configuration. VELCRO.™. strips can be used to reversibly attach the leash and collar portions. Another embodiment of the invention includes a restraint system which includes a collar assembly coupled to a leash assembly. The collar assembly and the leash assembly are made from separate straps and are attached to each other by a connecting element. The connecting element can be, for example, a restraining ring, a rivet or thread (in which case the collar assembly is fixedly attached to the leash assembly), or a clasp (in which case the collar assembly is reversibly attached to the leash assembly). Both the collar assembly and the leash assembly include VELCRO.™. strips which enable the leash assembly to be held to the collar assembly (and itself) when the leash assembly is wrapped around the collar assembly in an overlapping spiral configuration.

Noyes, U.S. Pat. No. 6,016,772 discloses a multifunction collar, harness, belt or leash is provided having a accordion-fold portion that collapses to a thin shape when the collar, harness, belt or leash is in use and pulled to a taut or tight condition, and that expands when the collar, harness, belt or leash is released to a slack condition, the expanded accordion-fold portion then providing an open-top bowl or cup.

Hanada, U.S. Pat. No. 6,129,055 discloses a ring belt. Locking units are provided in both ends of the ring belt so that they may be removably coupled to each other. An extension is formed to start from the end of the ring belt in which one locking unit is provided to extend along by the inside of the ring. A coupling ring is provided in the top end of the extension for holding a lead or a lifeline. Another coupling ring is also provided in the position corresponding to the coupling ring in the ring belt for holding a lead or a lifeline while both the locking units remain locked together. Such an arrangement enables both these coupling rings to be located in the adjacent positions with both locking units locked together so that the lead may be connected with both coupling rings. This will cause a force from the lead to be transmitted to the extension in such a way that there is no influence of this force on both locking units.

Our prior art search with abstracts described above teaches the use of retractable leash devices for attachment to a dog collar and various collar leash combinations. However, the present invention adds further advantages in that the leash is stored in a retracted orientation on the collar in such a manner that it is always present and easy to use and does not add appreciable bulk to the collar. The prior art fails to teach this important improvement.

### SUMMARY OF THE INVENTION

The present invention teaches certain benefits in construction and use which give rise to the objectives described below.

In one of the best mode preferred embodiments of the present invention, a unitary, flexible strap has an adjustable closure at its free ends such that the ends may be joined to form a closed loop of selected diameter, i.e., a collar. The strap has an outer surface to which an enclosure is fixedly mounted, the enclosure providing an interior space for rotationally mounting a spool. The spool provides a cord wrapped around it so that the cord may be fed out from the spool by rotation, the cord feeding through an aperture in the enclosure upon pulling on a handle mounted at a free end of the cord. The handle and cord form a leash for control of an animal when the strap is fastened about the animal. Velcro® is used to fasten the handle to the strap when not in use.

A primary objective of the present invention is to provide an apparatus and method of use of such apparatus that yields advantages not taught by the prior art.

Another objective of the invention is to provide a collar which may be fastened about a dog's neck. The collar provides a spool of cord used for a leash which may be extended or retracted to the collar so that the collar and cord may be always joined.

A further objective of the invention is to provide a handle at the end of the cord for withdrawing the cord from the collar.

A still further objective of the invention is provide a means for securing the handle to the collar when not in use.

Other features and advantages of the embodiments of the present invention will become apparent from the following more detailed description, taken in conjunction with the accompanying drawings, which illustrate, by way of example, the principles of at least one of the possible embodiments of the invention.

### BRIEF DESCRIPTION OF THE DRAWINGS

The accompanying drawings illustrate at least one of the best mode embodiments of the present invention. In such drawings:

FIG. 1 is a perspective view of a strap for use as a collar for an animal, the strap shown unfastened.

FIG. 2 is a further perspective view thereof shown fastened;

FIG. 3 is a perspective view of the invention as engaged around a dog's neck;

FIG. 4 is a side sectional view of the invention as taken from FIG. 2 along line 4-4 so as to show the interior of an enclosure thereof.

### DETAILED DESCRIPTION OF THE INVENTION

The above described drawing figures illustrate the present invention in at least one of its preferred, best mode embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

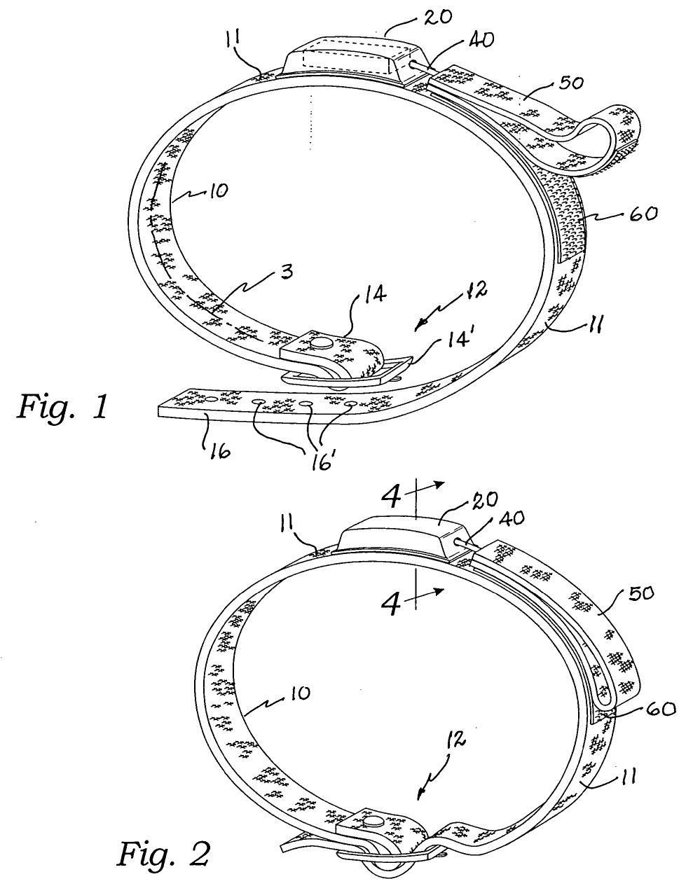

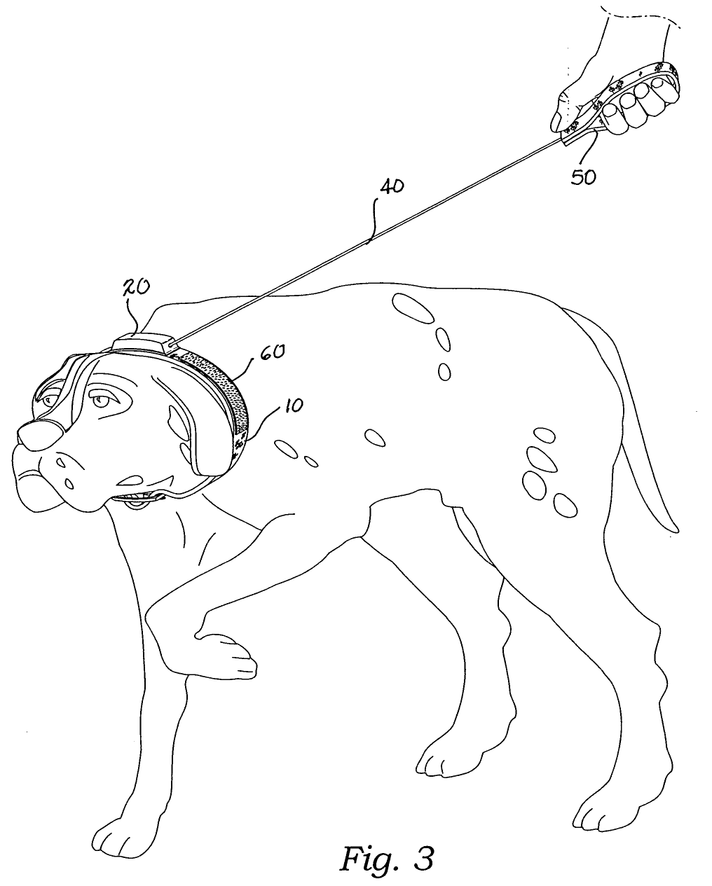

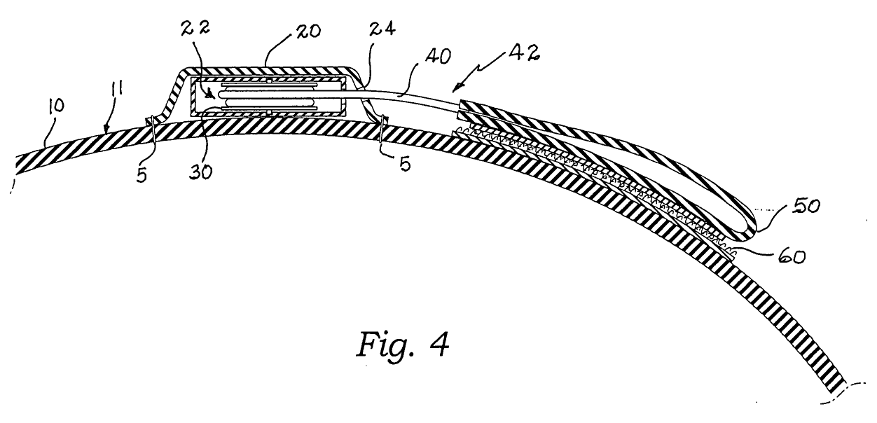

In one embodiment of the present invention an animal collar is as shown in FIGS. 1 and 2. The collar is formed preferably as a flexible strap 10, preferably of leather, plastic, or similar materials, having an adjustable closure 12 at its free ends 14 and 16. In this way the ends 14 and 16 may be joined together to form a closed loop (FIG. 2) of selected diameter so as to fit snuggly about a selected animal's neck as shown in FIG. 3. FIG. 2 shows a traditional closure; buckle 14′ on the one end 14 and holes 16′ on the other end 16. As shown, the strap 10 has an outfacing surface 11. Fixedly mounted on the outfacing surface 11 of the strap 10, is an enclosure 20 which provides an interior space 22 therewithin. The enclosure 20 may be attached to the strap 10 by stitches 5 for instance. A spool 30 is rotationally mounted within the interior space 22. The spool 30 provides a cord 40 wrapped around it so that the cord 40 may be fed-out from the spool 30 upon rotation thereof. The cord 40 may be a wire, a strap such as a leather strap, a ribbon (very thin strap), or a chain or other flexible elongated element that is able to be wound onto spool 30. The cord 40 may be fed back onto the spool 30 as desired and such spools are usually spring-loaded, as is very well known in the art, so that the act of cord extension winds the spring (not shown) tightly so that the spring is able to rotate the spool 30 in order to rewind the cord 40 back on the spool 30 when desired. The enclosure 20 has an aperture 24, as shown in FIG. 4, through which the cord 40 extends. A handle 50, preferably a strap type handle as shown in FIG. 4, is mounted at a free end 42 of the cord 40, the handle 50 and cord 40 together forming a leash for control of an animal when the strap 10 is fastened about the animal. Such strap fastening may be about the animal's neck, as shown in FIG. 3, but also may clearly be about other portions of an animal's anatomy such as the chest or waist as is also known so that such a strap 10 may be longer or shorter as each case requires, or the strap 10 may indeed be a harness of any type well known in the art.

In the preferred embodiment, the strap 10 provides a fastener 60, such as a hook and loop surface-to-surface fastening material, like Velcro®, and the handle 50 is preferably removably secured by the fastener 60 to the strap 10 when the cord 40 is retracted onto the spool 30 as is shown in FIG. 4. The permanent fastening of the enclosure 20 to the exterior surface of the strap 10 provides a significant advantage over the prior art in that the enclosure, along with its cord winding capability makes it impossible to leave the leash behind and satisfies the long felt need of finding a way of assuring that the leash cannot be misplaced or lost since it is always mounted on the animal.

In the preferred embodiment, the enclosure 20 is configured so as to be no wider than strap 10, but in alternate embodiments, the enclosure 20 might be larger in size than shown in the figures so as to support a larger spool 30, and a correspondingly more robust and/or longer cord 40. The aperture 24 is placed such that the cord 40 plays out along the longitudinal axis 3 (FIG. 1) of the strap 10 so that with the cord 40 fully retracted, the handle lays in adjacency with the enclosure 20 and also along the longitudinal axis 3. This provides the great advantage of securing the handle in such a manner that it becomes a part of the strap collar when not in use, is not easily caught or snagged as the animal, for instance a dog, move about and is easily gripped and removed from the strap 10 when necessary. Preferably, the loop portion of the hook and loop material 60 is mounted on the handle 50 so that it is not abrasive to the skin of the hand holding the handle 50; while the hook portion is mounted on the outfacing surface 11 of the strap 10.

The above described invention may be further described as follows, wherein the same numerals are used to refer to the same elements although the elements are described using more general terminology. An animal collar apparatus comprises a means for removably engaging 10 a portion of an animal's anatomy, a means for storing a cord 30 including a cord 40 stored therewith, the cord storing means 30 enabled for extending the cord 40 from the cord storing means 30 and for retracting the cord 40 onto the cord storing means 30 as desired. The cord storing means 30 is permanently attached to the anatomy engaging means 10. The cord 40 has a free end 42, opposite to that portion of the cord 40 engaged with the cord storing means 30, wherein the free end 42 terminates with a means for hand gripping 50 such as a strap loop, T-bar and such. The anatomy engaging means 10 provides a means for attachment 60 enabled for engaging the hand gripping means 50 in a position on the anatomy engaging means 10 adjacent to the cord storing means 30. Preferably, the hand gripping means 50 is oriented along a common longitudinal axis 3 with the anatomy engaging means 10 when the hand gripping means 50 is engaged with the attachment engaging means.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. An animal collar apparatus comprising: a unitary, flexible strap having an adjustable closure at its free ends such that said ends may be joined to form a closed loop of selected diameter, the strap having an outer surface and an inner surface; an enclosure fixedly mounted on the outer surface of the strap, the enclosure providing an interior space therewithin; a spool rotationally mounted within the interior space, the spool providing a cord wrapped there around so that the cord may be fed out from the spool upon rotation thereof; the enclosure providing an aperture through which the cord extends; a handle mounted at a free end of the cord, the handle and cord forming a leash for control of an animal when the strap is fastened about the animal.

2. The apparatus of claim. 1 wherein the strap provides a fastener mounted thereon, the handle secured by the fastener to the strap when the cord is retracted about the spool.

3. The apparatus of claim 2 wherein the fastener is a hook and loop surface fastening means.

4. The apparatus of claim 2 wherein the enclosure is oriented along a longitudinal axis of the strap with the aperture placed for playing out the cord along the longitudinal axis of the strap.

5. The apparatus of claim 4 wherein the fastener is oriented adjacent to the aperture of the enclosure.

6. The apparatus of claim 5 wherein the handle is oriented along the longitudinal axis of the strap when engaged with the strap by the fastener.

7. The apparatus of claim 1 wherein the handle is not wider than the strap.

8. An animal collar apparatus comprising: a means for removably engaging a portion of an animal's anatomy; a means for storing a cord including a cord stored therewith, the cord storing means enabled for extending the cord from the cord storing means and for retracting the cord into the cord storing means as desired; the cord storing means permanently attached to the anatomy engaging means, the cord having a free end terminating with a means for hand gripping, the anatomy engaging means providing a means for attachment enabled for engaging the hand gripping means in a position on the anatomy engaging means adjacent to the cord storing means.

9. The apparatus of claim 8 wherein the hand gripping means is oriented along a common longitudinal axis with the anatomy engaging means when the hand gripping means is engaged with the attachment engaging means.
